(19) United States
(12) Patent Application Publication
(10) Pub. No.: US 2008/0010535 A1
(43) Pub. Date: Jan. 10, 2008

(54) AUTOMATED AND CONFIGURABLE SYSTEM FOR TESTS TO BE PICKED UP AND EXECUTED

(75) Inventor: Koushik Dasgupta, Hyderabad (IN)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/423,236

(22) Filed: Jun. 9, 2006

(51) Int. Cl. G06F 11/00

(52) U.S. Cl. 714/38

(57) ABSTRACT

The claimed subject matter provides a system and/or a method that facilitates automatically testing software code. An interface can facilitate receipt of a segment of executable code. A test component can automatically identify a test kit related to the segment of code and product a test result. In addition, the test component can automatically compile the segment of executable code to produce at least one of an executable file and a dynamically linked library (DLL) file.

### BACKGROUND

Software application testing systems have been around for quite some time. Testing systems are fueled by consumer demand for high quality and reliable software. Accordingly, newly developed or extended software applications will not be released by software development companies until and unless they pass the tests developed for them (e.g., functional, load, unit, integration . . . ). Testing begins by clearly and completely defining requirements for a software application (e.g., functional requirements, performance requirements . . . ). These requirements can be employed to more clearly delineate the scope of an application in development. A test plan can then be devised that captures requirements, for example by dividing an application up into functional units. Thereafter, tests can be designed and developed that examine application functions in terms of expected results, for instance. If upon test termination functional unit values are different than expected results, then the application has failed the test. Accordingly, the software under test will or has failed to meet a defined application requirement. Subsequently, defects can be analyzed and fixes applied to the code. One or more tests can then be re-executed and the process repeated until successful.

Fortunately, developers and testers do not have to tackle software testing manually. Presently, there are various software test management systems that automate all or part of the testing process. However, effective software testing has two requirements that are in conflict in conventional test management systems. First, large amounts of data need to be accessible in a form that provides ready querying and reporting, to view exception patterns, trends, productivity, success rates, among other things, over the breadth of a team and over the course of a software lifecycle. Second, individual tests are intimately tied to specific versions of software under test (SUT).

Test automation is very important for a product in order to catch basic bugs and regression bugs. As the complexity of product increases the number of required tests also increases and without simple and well organized test automation process it is not easy to analysis test results and introduce new tests. In the conventional software world, running tests seamlessly and producing the correct result out of such tests is an extremely difficult task. There are many solutions available in market which tries to achieve such an optimistic goal, but none work in a “truly automated” fashion and/or manner.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate automatically testing software to provide test results without any manual interaction. A test component can automatically identify a test kit associated with a particular segment of executable code and automatically produce a test kit result. The test component can receive data via an interface, wherein the data can be, for instance, any suitable software code associated with at least one of a test kit, a segment of executable code, a software code, extensible markup language (XML), C sharp, C++, structured query language (SQL), hypertext markup language (HTML), any suitable software code, and/or any combination thereof. The test component can dynamically and automatically identify the test kit and respective data (e.g. executable code segment) to provide the test result with minimal and/or no delay. Conventionally, the identification of test kits and respective segments of executable code and the production of test results were manually implemented by, for example, a user. Furthermore, the test component can allow internal test developers the ability to analyze test results, code coverage, and introduce new test cases without actually changing a basic infrastructure.

In accordance with one aspect of the claimed subject matter, the test component can provide automatic test results in relation to an RFID infrastructure. The test component can be utilized in conjunction with the RFID infrastructure, wherein data related to the RFID infrastructure can be automatically identified, compiled, and tested. The RFID infrastructure can include an RFID server within a host that can communicate with an RFID network of physical devices via a provider, wherein the devices can receive wirelessly transmitted data from a tag. For example, the data received with the interface can be related to at least a portion of an RFID process related to the RFID infrastructure. Such data can be automatically identified (e.g., a developer segment of code matched with a test segment of code), compiled, tested, and reported.

In accordance with another aspect of the claimed subject matter, the test component can further utilize a source depot that can be a central location for developer data (e.g., a developer segment of executable code) and/or a test data (e.g. a test segment of executable code). The test component can utilize the source depot to receive at least one of developer data and test data such that the test component can automatically identify, compile, test, and report results. In addition, the test component can include an identify component that can match developer data with respective test data. The identify component can associate a developer data with a respective test data and vice versa. In other aspects of the claimed subject matter, methods are provided that facilitate automatically detecting a test kit and respective executable code and producing a test result.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates automatically testing software.

FIG. 2 illustrates a block diagram of an exemplary system that facilitates automatically detecting a test kit and respective executable code and producing a test result.

FIG. 3 illustrates a block diagram of an exemplary system that facilitates receiving test data and development data to automatically provide test kit results.

FIG. 4 illustrates a block diagram of an exemplary system that facilitates identifying and producing test results in relation to a test kit and an associated segment of executable code.

FIG. 5 illustrates an exemplary report of test results automatically produces in relation to a segment of code and a test kit.

FIG. 6 illustrates a block diagram of an exemplary system that facilitates automatically detecting a test kit and respective executable code and producing a test result.

FIG. 7 illustrates a block diagram of an exemplary system that facilitates distributing automated test kit results to a plurality of targets.

FIG. 8 illustrates a block diagram of an exemplary system for test automation associated with a radio frequency identification (RFID) environment.

FIG. 9 illustrates an exemplary methodology that facilitates automatically testing software.

FIG. 10 illustrates an exemplary methodology that facilitates automatically detecting a test kit and respective executable code and producing a test result.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “compiler,” “machine,” “generator,” and the like are intended to refer to a computer-related entity, either hardware, software (e.g. in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

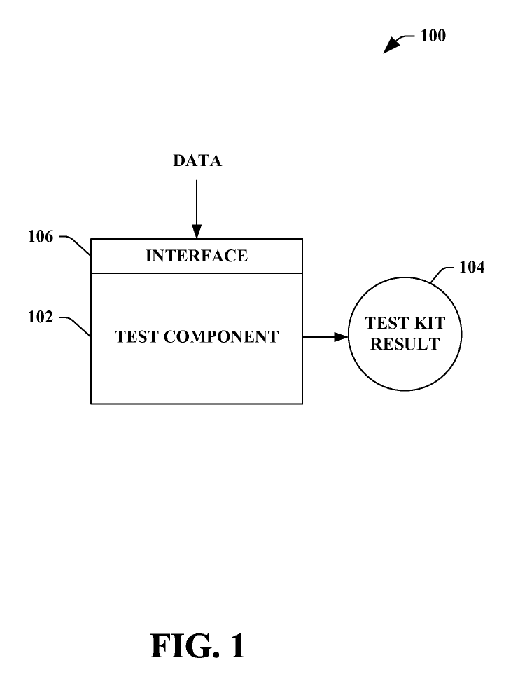

Now turning to the figures, FIG. 1 illustrates a system 100 that facilitates automatically testing software to provide test results without any manual interaction. The system 100 can include an interface component 106 (herein referred to as the “interface 106”) that facilitates receipt of data, wherein a test component 102 can automatically identify a test kit respective to data allowing the automatic production of a test kit result 104. The data received via the interface 106 can be any suitable software code associated with at least one of a test kit, a segment of executable code, a software code, extensible markup language (XML), C sharp, C++, structured query language (SQL), hypertext markup language (HTML), any suitable software code, and/or any combination thereof. The test component 102 can dynamically and automatically identify the test kit and respective data (e.g., executable code segment) to provide the test result 104 with minimal and/or no delay. Conventionally, the identification of test kits and respective segments of executable code and the production of test results were manually implemented by, for example, a user.

The test component 102 can provide automatic test results in relation to identifying a test kit and a respective segment of executable code. Without any manual interaction in the process of producing the test kit result 104, error can be reduced, while reliability and efficiency can be increased. The test component 102 can allow internal test developers the ability to analyze test results, code coverage, and introduce new test cases without actually changing the basic infrastructure of the system 100. In other words, by implementing the test component 102 that can automatically pick up a test kit respective to software code, test results 104 can be automatically ascertained without any user intervention.

For example, a test segment of code and a developer segment of code can be received via the interface 106. Once the test component 102 identifies the test segment of code and the developer segment of code are available, the test results 104 can be produced automatically. In other words, a developer segment of code can be received at a first instance of time, and a test segment of code can be received at a second instance of time such that the test component 102 can dynamically produce test results 104 based at least in part upon identification of the received relationship. Thus, various versioning of developer segment of code and test segment of code can be automatically identified, compiled, tested, and reported.

In another aspect in accordance with the subject innovation, the test component 102 can automatically compile the test kit and associated segment of data to produce the test kit result 104. For instance, the test component 102 can compile the source code to produce at least one of an executable file and a dynamically linked library (DLL) file. Once the source code is compiled, the test component 102 can automatically produce the test kit results 104 based on the compilation of the source code and running the test kit therewith. Since the test component 102 can provide complete automation of the identification, compilation, and production of test results, test automation is vastly improved and/or enhanced. Moreover, such test kit results 104 can be distributed to various entities, targets, users, developers, testers, systems, components, databases, etc.

The test component 102 can be utilized in conjunction with an RFID infrastructure (not shown), wherein data related to the RFID infrastructure can be automatically identified, compiled, and tested. For instance, the RFID infrastructure can include an RFID server within a host that can communicate with an RFID network of physical devices via a provider, wherein the devices can receive wirelessly transmitted data from a tag. For example, the data received with the interface 106 can be related to at least a portion of an RFID process related to the RFID infrastructure. Such data can be automatically identified (e.g., a developer segment of code matched with a test segment of code), compiled, tested, and reported.

Moreover, the system 100 can include any suitable and/or necessary interface component 106 (herein referred to as “interface 106”), which provides various adapters, connectors, channels, communication paths, etc. to integrate the organizational manager 102 into virtually any operating and/or database system(s). In addition, the interface 106 can provide various adapters, connectors, channels, communication paths, etc., that provide for interaction with the organizational manager 102, the RFID network 104, and any other device and/or component associated with the system 100.

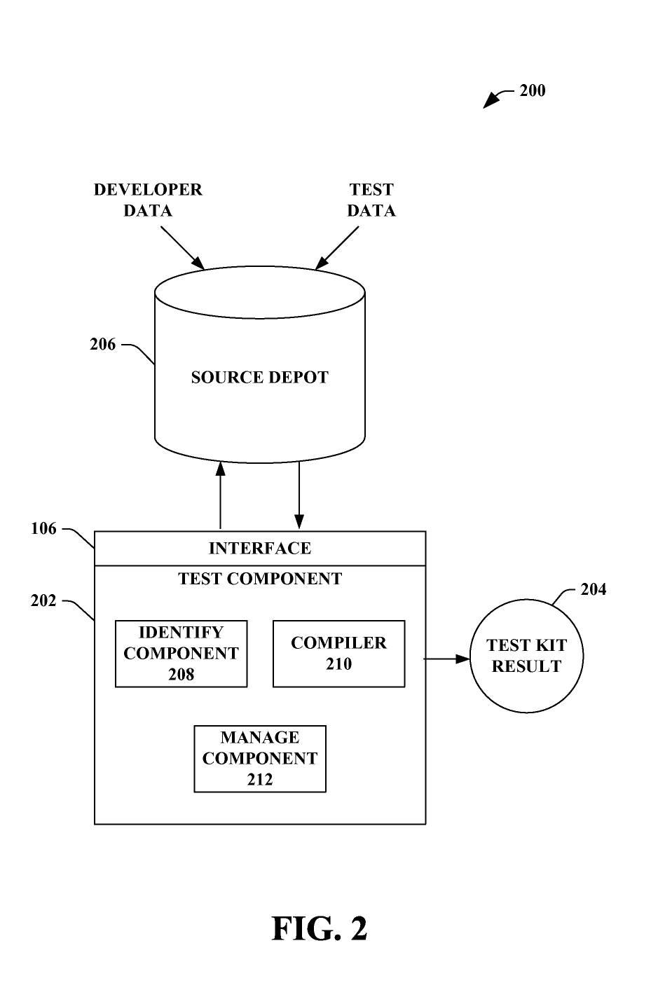

FIG. 2 illustrates a system 200 that facilitates automatically detecting a test kit and respective executable code and producing a test result 204. The system 200 can include a test component 202 that can automatically create a test kit result 204 upon receipt of data via the interface 106. By automating the testing procedure, the test component 202 facilitates analyzing test results, code coverage and introducing new test cases without disturbing the system 200. For instance, the test component 202 can receive data (e.g., software code, any suitable programming code, executable segment, a test kit, a segment of executable code, extensible markup language (XML), C sharp, C++, structured query language (SQL), hypertext markup language (HTML), hybrid of at least two disparate code languages, and/or any combination thereof), detect a testing procedure and/or kit for a particular code segment, and automatically run the test procedure and/or test kit to provide test results. It is to be appreciated that the test component 202 can be substantially similar to the test component 102 as illustrated in FIG. 1.

The system 200 can include a source depot 206 that can be invoked to store developer data and/or test data. Thus, any suitable computer programming code can be stored in the source depot 206. In one example, the source depot 206 can include, but is not limited to including, a segment of executable code, a segment of developer executable code, a segment of test executable code, a test kit, a test, a portion of code (e.g., software code, any suitable programming code, executable segment, extensible markup language (XML), C sharp, C++, structured query language (SQL), hypertext markup language (HTML), hybrid of at least two disparate code languages, etc.), test settings, test machine settings and/or assignments, a schedule of testing, profiles, security settings, passwords, usernames, lifespan configurations for data, etc.

It is to be appreciated that the source depot 206 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The source depot 206 of the subject systems and methods is intended to comprise, without being limited to, these and any other suitable types of memory. In addition, it is to be appreciated that the source depot 206 can be a server, a database, a hard drive, and the like.

The test component 202 can include an identify component 208 that can match developer data with respective test data. It is to be appreciated that the developer data need not be created and/or uploaded to the source depot 206 by a developer and the test data need not be created and/or uploaded to the source depot 206 by a tester. However, the developer data can be any suitable data and/or code that can be developed, while the test data can be any suitable data and/or code that can be utilized to test the developed data. Thus, the identify component 208 can ascertain various compatibilities, versions, matches, etc. in relation to test data and developer data. For instance, an executable segment of code can be uploaded to the source depot 206 and a test kit and/or code can be uploaded to the source depot 206. Such test kit can be automatically identified to be utilized with the executable segment of code by the identify component 208, from which the test kit result 204 can be simultaneously produced. Moreover, if an updated version of the substantially similar executable code is uploaded, the system 200 can provide additional test kit results 204 related to the previously utilized test kit, and/or await a newer version for the respective test kit to be identified and utilized.

The test component 202 can further include a compiler 210 that can compile at least one of a developer data, a test data, a segment of executable code, a segment of developer executable code, a segment of test executable code, a test kit, a test, a portion of code (e.g., software code, any suitable programming code, executable segment, extensible markup language (XML), C sharp, C++, structured query language (SQL), hypertext markup language (HTML), hybrid of at least two disparate code languages), etc. Thus, the compiler 210 can accept source code and/or any other suitable data as input and produces implementation code as output. For instance, the compiler 210 can compile developer data to produce an executable file and/or a dynamically linked library (DLL) file, from which the compiled data can be tested with the identified test data to create the test kit result 204.

Moreover, the test component 202 can include a manage component 212 that can control the automatic employment of an identified developer data and respective test data to provide the test kit result 204. In one example, the test data and the developer data (e.g. which can also be compiled via the compiler 210) can be utilized in at least one of a test machine, a computer, a simulator, hardware, etc. In other words, each identified developer data and test data can be assigned to a particular location for automatic test results to be created and the manage component 212 can ascertain the particular location for the data.

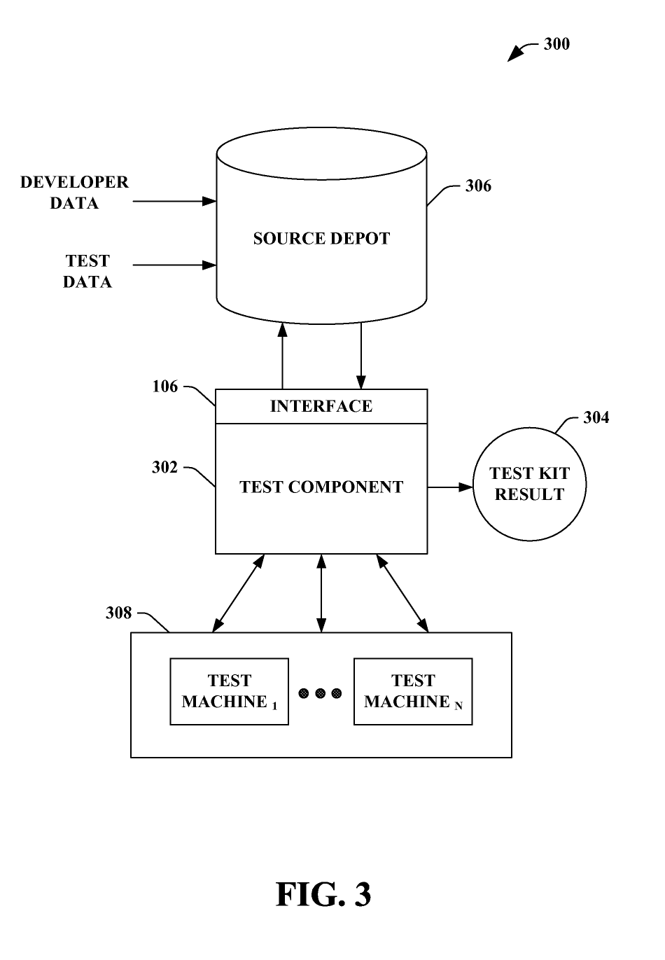

FIG. 3 illustrates a system 300 that facilitates receiving test data and developer data to automatically provide test kit results. The system 300 can include a source depot 306 that can store at least one of developer data and test data, wherein the interface 106 allows communication and/or receipt of such data for a test component 302. The test component 302 can automatically identify test data and related developer data and produce a test kit result 304 based at least in part upon the data tested and the test employed. It is to be appreciated that the test component 302 can provide the following: automatic identification of code and respective test; compilation of code; automatic creation of test results; and reporting of such results. Moreover, the test component 302 can be utilized in conjunction with any suitable developer data, test data, source code, computer programming language, etc. to provide test kit results 304.

The test component 302 can automatically test a developer data with test data utilizing a test framework 308, such that the test framework 308 can include any suitable number of test machines from test machine₁ to test machine_{N}, where N is an integer. For instance, the test framework 308 can include a test machine respective to each test that is to be initiated. For instance, a user can insist on five tests to be employed for code segments. Thus, the test framework 308 can include five distinct test machines that respectively implement the particular test. It is to be appreciated that the test component 302 can manage and/or dictate which data is to be tested in which location and/or at what instance of time based at least in part upon a schedule, a pre-determined schedule, a first-in-first-out basis, on-demand, etc.

The test component 302 can be utilized in conjunction with an RFID infrastructure (not shown), wherein data related to the RFID infrastructure can be automatically identified, compiled, and tested. For instance, the RFID infrastructure can include an RFID server within a host that can communicate with an RFID network of physical devices via a provider, wherein the devices can receive wirelessly transmitted data from a tag. For example, the data received with the interface 106 can be related to at least a portion of an RFID process related to the RFID infrastructure. Such data can be automatically identified (e.g., a developer segment of code matched with a test segment of code), compiled, tested, and reported by the test component 302.

It is to be appreciated that the RFID process can utilize any suitable number of devices within the RFID network. An RFID process can be related to a particular RFID sub-system (e.g., the RFID server, the host, RFID network, etc.) that is an uber or high-level object that forms together various entities to create a meaningful unit of execution. The RFID process can be and/or can include an outbound process (e.g., pick, pack, shipping scenario, etc.), a manufacturing process, a shipping process, a receiving process, tracking, data representation, data manipulation, data application, security, etc. Additionally, the RFID process can include and/or respond to a device service, a tag read, an event, a tag write, a device configuration, a geographic tracking, a number count, etc. It is to be appreciated that the process can have raw data collected via at least one device associated with the RFID network, wherein such raw data can be manipulated based at least in part upon a rule and/or a business rule engine (not shown).

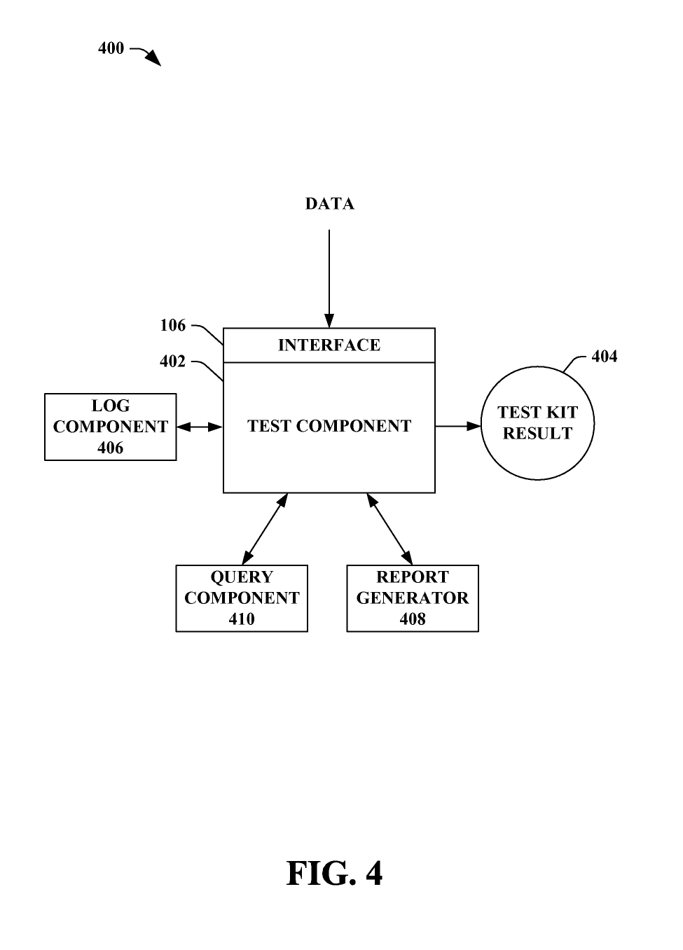

FIG. 4 illustrates a system 400 that facilitates identifying and producing test results in relation to a test kit and an associated segment of executable code. The system 400 can include a test component 402 that can automatically identify a first set of data that relates to a second set of data and automatically produce a test kit result 404 there from. In other words, the system 400 allows data to be identified and picked up automatically and run to produce a test result without any manual interaction associated therewith. It is to be appreciated that the test component 402 can be substantially similar to previously described test components in earlier figures.

The system 400 can further include a log component 406 that can log various data associated with the system 400. For instance, the log component 406 can log data such as, but not limited to, test kit results, reporting out locations, identification of machine testing, a segment of executable code, a segment of developer executable code, a segment of test executable code, a test kit, a test, a portion of code (e.g., software code, any suitable programming code, executable segment, extensible markup language (XML), C sharp, C++, structured query language (SQL), hypertext markup language (HTML), hybrid of at least two disparate code languages, etc.), test settings, test machine settings and/or assignments, a schedule of testing, profiles, security settings, passwords, usernames, lifespan configurations for data, etc.

Furthermore, the test component 402 can include a report generator 408 that can generate at least one report in accordance with the test kit result 404. For instance, a report can be generated to include various data related to the automatic tests and/or data log with the log component 406. In addition, the report can be generated and then distributed to various entities, targets, users, developers, testers, systems, components, databases, etc. (discussed infra). In one example, the following test summary (Table 1) can be produced by the report generator 408, yet it is to be appreciated that the following is solely an example and the subject innovation is not so limited:

TABLE 1
Test Summary

| Machine | Process | | | | | | | Pass |
|---|---|---|---|---|---|---|---|---|
| Name | Name | Total | Pass | Fail | Warnings | Blocked | Skipped | Rate |
| 1. RFID- | RTTSb.exe | 15 | 15 | 0 | 0 | 0 | 0 | 100% |
| 1PW3S2 | | | | | | | | |
| 2. RFID- | RTTSb.exe | 15 | 15 | 0 | 0 | 0 | 0 | 100% |
| 1PW3Y20 | | | | | | | | |
| 3. RFID- | RTTSb.exe | 15 | 15 | 0 | 0 | 0 | 0 | 100% |
| 1PW3Y25 | | | | | | | | |
| 4. RFID- | RTTSb.exe | 15 | 15 | 0 | 0 | 0 | 0 | 100% |
| 1PW3Y26VPC | | | | | | | | |
| 5. RFID- | RTTSb.exe | 15 | 15 | 0 | 0 | 0 | 0 | 100% |
| 1PW3Y3 | | | | | | | | |
| 6. RFID- | RTTSb.exe | 15 | 15 | 0 | 0 | 0 | 0 | 100% |
| 1PXPSE1 | | | | | | | | |
| 7. RFID- | RTTSb.exe | 15 | 15 | 0 | 0 | 0 | 0 | 100% |
| 1PXPY22VPC | | | | | | | | |
| 8. RFID- | RTTSb.exe | 15 | 15 | 0 | 0 | 0 | 0 | 100% |
| TESTRUN | | | | | | | | |
| 9. RFID- | RTTSb.exe | 15 | 15 | 0 | 0 | 0 | 0 | 100% |
| TESTRUN2 | | | | | | | | |
| 10. RFID- | RTTSb.exe | 15 | 15 | 0 | 0 | 0 | 0 | 100% |
| TESTXPROC1 | | | | | | | | |

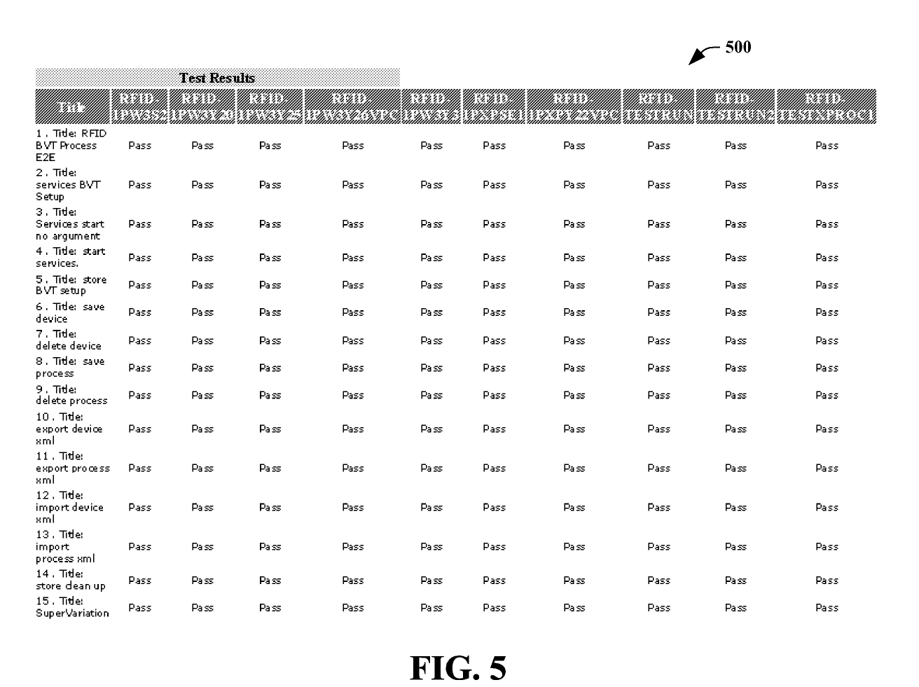

Turning briefly to FIG. 5, a report 500 is illustrated that can be associated with automatically identifying and producing a test result. As indicated previously, the report 500 is an example of a test result report and the claimed subject matter is not to be so limited. In addition, the report generator 408 can create a code coverage report such as the following identified as Table 2:

TABLE 2

| | | | Arcs | | | | | Blocks | |
|---|---|---|---|---|---|---|---|---|---|
| | | | Hit | Arcs Missed | | | Blocks | Hit | Blocks |
| ID | Name | Arcs | Arcs | Arcs | | Arcs % | Blocks | Blocks | Missed |
| ID | Name | Arcs | Hit | Missed | Arcs % | Blocks | Hit | Missed | Blocks % |
| 1 | 111 | 130182 | 46945 | 83237 | 36.1 | 120015 | 48012 | 72003 | 40.0 |
| 2 | 89.306 | 20418 | 15226 | 5192 | 74.6 | 19211 | 15582 | 3629 | 81.1 |
| 3 | 89.307 | 61254 | 45672 | 15582 | 74.6 | 57633 | 46742 | 10891 | 81.1 |
| 4 | 89.308 | 45487 | 34077 | 11410 | 74.9 | 42617 | 34587 | 8030 | 81.2 |
| 5 | 89.309 | 20423 | 15271 | 5152 | 74.8 | 19214 | 15614 | 3600 | 81.3 |
| 6 | 89.313 | 20423 | 15259 | 5164 | 74.7 | 19214 | 15608 | 3606 | 81.2 |
| 7 | 89.315 | 20423 | 1460 | 18963 | 7.1 | 19214 | 1604 | 17610 | 8.3 |
| 8 | 89.317 | 25065 | 18621 | 6444 | 74.3 | 23400 | 18787 | 4613 | 80.3 |
| 9 | 89.318 | 25065 | 18601 | 6464 | 74.2 | 23400 | 18771 | 4629 | 80.2 |
| 10 | 89.320 | 25049 | 18570 | 6479 | 74.1 | 23380 | 18745 | 4635 | 80.2 |
| 11 | 89.321 | 20403 | 15026 | 5377 | 73.6 | 19193 | 15396 | 3797 | 80.2 |
| 12 | 89.323 | 24965 | 4642 | 20323 | 18.6 | 23307 | 5256 | 18051 | 22.6 |
| 13 | 89.329 | 25027 | 18275 | 6752 | 73.0 | 23373 | 18511 | 4862 | 79.2 |
| 14 | 89.330 | 25035 | 18616 | 6419 | 74.4 | 23379 | 18792 | 4587 | 80.4 |
| 15 | 89.332 | 25035 | 18631 | 6404 | 74.4 | 23379 | 18805 | 4574 | 80.4 |
| 16 | 89.333 | 20340 | 15027 | 5313 | 73.9 | 19148 | 15404 | 3744 | 80.4 |
| 17 | 89.334 | 25033 | 18731 | 6302 | 74.8 | 23377 | 18894 | 4483 | 80.8 |
| 18 | 90.338 | 20340 | 15097 | 5243 | 74.2 | 19148 | 15469 | 3679 | 80.8 |
| 19 | 90.340 | 20340 | 15145 | 5195 | 74.5 | 19148 | 15514 | 3634 | 81.0 |
| 20 | 90.342 | 25033 | 18780 | 6253 | 75.0 | 23377 | 18941 | 4436 | 81.0 |
| 21 | 90.343 | 20340 | 15194 | 5146 | 74.7 | 19148 | 15559 | 3589 | 81.3 |
| 22 | 90.344 | 20340 | 15194 | 5146 | 74.7 | 19148 | 15559 | 3589 | 81.3 |
| 23 | 90.346 | 25033 | 6547 | 18486 | 26.2 | 23377 | 7282 | 16095 | 31.2 |
| 24 | 90.348 | 25033 | 11335 | 13698 | 45.3 | 23377 | 10975 | 12402 | 46.9 |

The above code coverage can be employed by a code coverage tool. Before executing a test case, the corresponding DLLs can be corresponded to start code coverage process with instrumented DLLs to be used as test cases. After test completion, code coverage report can be generated and saved in a database, a data store, hard drive, and the like.

Moreover, the system 400 can include a query component 410 that allows the querying of such data stored and/or logged, and data reported. In other words, the query component 410 can allow a user to search any data associated with the system 400.

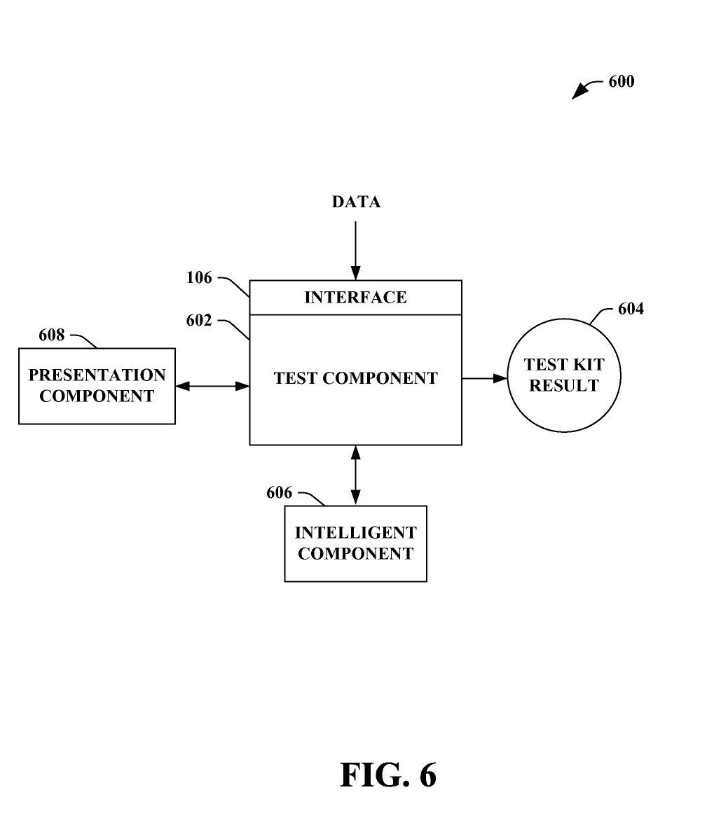

FIG. 6 illustrates a system 600 that employs intelligence to facilitate automatically detecting a test kit and respective executable code and producing a test result. The system 600 can include a test component 602 that receives data via the interface 106 to automatically provide a test kit result 604 related to the data. For instance, the data can be a developer segment of executable code and a test segment of executable code. It is to be appreciated that the test component 602, the interface 106, and the test result 604 can be substantially similar to respective components, test kit results, and interfaces described in previous figures. The system 600 further includes an intelligent component 606. The intelligent component 606 can be utilized by the test component 602 to facilitate automatically producing the test kit result 604. For example, the intelligent component 606 can infer identifying a test kit with a respective segment of executable code, entities and/or targets to report the test kit result, settings associated with running the test kits, compilation configurations, version association of code segments, developer code segments and respective test code segments, storage settings, life span of versions, storage locations, test machine assignment, etc.

It is to be understood that the intelligent component 606 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The test component 602 can further utilize a presentation component 608 that provides various types of user interfaces to facilitate interaction between a user and any component coupled to the test component 602. As depicted, the presentation component 608 is a separate entity that can be utilized with the test component 602. However, it is to be appreciated that the presentation component 608 and/or similar view components can be incorporated into the test component 602 and/or a stand-alone unit. The presentation component 608 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the test component 602.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

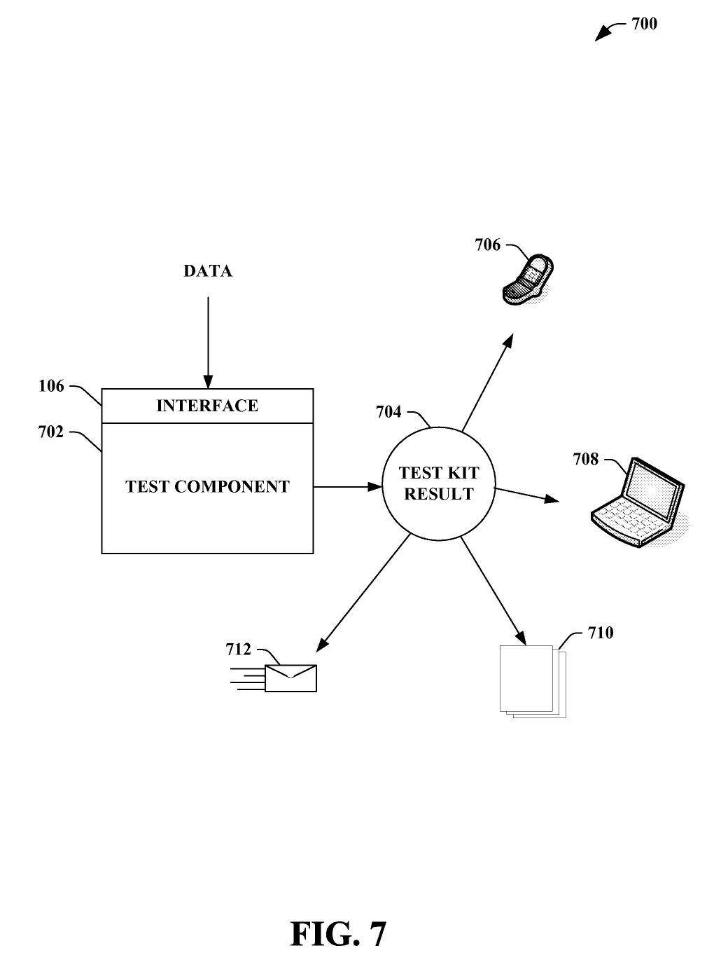

FIG. 7 illustrates a system 700 that facilitates distributing automated test kit results to a plurality of targets. The system 700 can include a test component 702 that automatically identifies a test segment of code and a related developer segment of code and automatically produces a test kit result 704. The test component can receive data (e.g. a test segment of code, a related developer segment of code, any suitable software code associated with at least one of a product and a test kit, a segment of executable code, a software code, extensible markup language (XML), C sharp, C++, structured query language (SQL), hypertext markup language (HTML), any suitable software code, and/or any combination thereof, etc.) via the interface 106. It is to be appreciated that the test component 702 and the test kit results 704 can be substantially similar to previously described components and results.

The test kit result 704 can be distributed to any entity, target, user, system, data store, data base, component, machine, etc. As depicted, the test kit result 704 can be distributed as a report 710, wherein the report 710 can be documents (e.g., HTML, word processing documents, print outs, hard-copies, soft-copies, etc.). In another example, the test kit result can be sent to a portable device 706. It is to be appreciated that the portable device 706 can be a mobile communication device, a cellular phone, a portable digital assistant (PDA), a messenger device, a smartphone, etc. In another example, the test kit result can be distributed to a computer 708, wherein the computer 708 can be a laptop, a desktop, a portable computer, and the like. In still another example, the test kit result can be distributed via email 712 to various recipients and/or users.

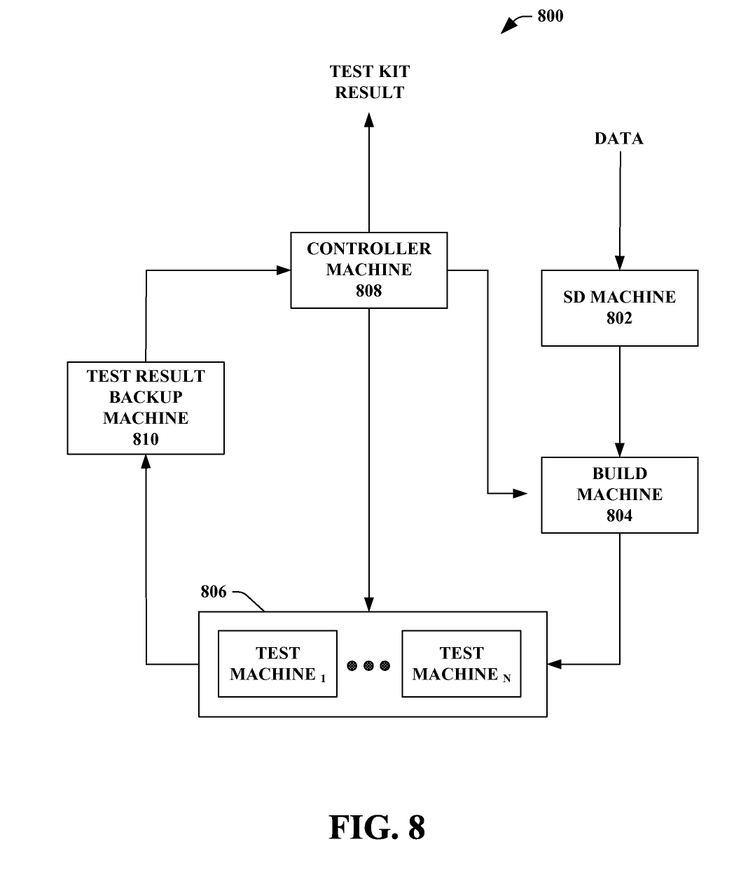

FIG. 8 illustrates a system 800 for test automation associated with radio frequency identification (RFID) environment. The system 800 can use an innovative technology for execution of test cases; a central location can store data, and a code coverage tool for code coverage. The test process utilized by the system 800 can employ a sequence of disparate jobs, wherein all jobs can be controlled by a controller machine 808 that can schedule different jobs on machines 806 based on a test requirement. The controller machine 808 can automatically produce a test kit result based on the jobs performed by the scheduled test jobs. The system 800 can include a source depot (SD) machine 802 that can receive data, wherein the data can be, but not limited to, any suitable software code associated with at least one of a test kit, a segment of executable code, a software code, extensible markup language (XML), C sharp, C++, structured query language (SQL), hypertext markup language (HTML), any suitable software code, and/or any combination thereof The SD machine 802 can be a central location where any source code and/or data can be stored. For instance, the source code associated with developer and/or testing can be stored in the SD machine 802.

A build machine 804 can receive data from the SD machine 802 and build a job. The “build job” runs in the build machine 804 to produce all required DLLs, binaries required, and execution files for the product. The detection of all the test cases from these test DLLs are done automatically by the system 800 without any human interaction. The system 800 can automatically detect all the test cases written by testers or developers and schedules them in different machines 806 having a test machine 1 to test machine N, where N is an integer. In other words, the machines 806 can provide the execution of tests on a pre-determined schedule (e.g., daily, weekly, hourly, etc.). The system can further include a test backup machine 801 that can store test results from the different machines 806.

The controller machine 808 can also act ass a start point for running tests. Moreover, the controller machine 808 can schedule jobs in all test machines. Before starting daily jobs, it starts a build job which can build the latest test binaries and copy all test inputs in a shared folder from where all test machines 806 can pick them up for executing test cases to produce test kit results. After build job, the controller machine 808 can start all test of each category. All test machines can back up the test results on the test result back up machine 810. After the tests are complete, the machines can take the tests results (e.g., result XML files) and create a test report and send out (e.g., to a team).

Overall, the system 800 allows a user to be unaware and/or not know how test cases written will be executed. In order to include their test case in daily execution, a class can be implemented that can inherit BaseTestCase. BaseTestCase class can inherit the IManagedItem class provided by the system 800. In addition, the BestTestCase class can catch all unhandled exceptions thrown by test case. For instance, the following pseudo code can illustrate a sample test case but is to be utilized as an example and not limiting on the claimed subject matter:

```
  public class RestoreTest:BaseTestCase
  {
    public bool Run(Context context)
    {
      bool passed=true;
      string backupXml=null;
      ServerManagerProxy
serverManager=(ServerManagerProxy)
RTTContextHandler.GetObjectParameter(context,“serverManager”);
      try
      {
        backupXml=serverManager.BackupServerState( );
        if(backupXml!=null)
        {
          serverManager.RestoreServerState(backupXml);
        }
      }
      catch(Exception e)
      {
        passed=false;
        GeneralUtil.WarnMessage(context,“execption while
backup/restore of server {0}”,e.Message);
      }
      ServerManagerCommon.PrintResult(context,passed);
      return passed;
    }
  }
```

### It is to be appreciated that the test automation can automatically pick the above test case when it is submitted to the SD machine 802.

Furthermore, the system 800 can utilize a categorization of test cases. In an example related to implementing the system 800 in an RFID infrastructure (not shown), the test automation can allow test to be categorized in the following categories: 1) BVT test cases; 2) DEV White Box tests; 3) Test White Box tests; 4) Dev Black Box tests; and 5) Test Black Box tests. For each test category different jobs can be maintained which provides freedom to run tests together and/or separately.

In general, the system 800 can utilize the following flow diagram steps in relation to providing automatic test results on a daily schedule: 1) synchronize build machine with source; 2) build latest binaries and copy them to a shared folder; 3) select test category from BVT, DEV, WB, Test, etc.; 4) invoke tests (BVT for example) on all tests; 5) merge all test results and create a report; 6) send report to a target such as a whole product team; and 7) return to 3). It is to be appreciated that the above is solely for exemplary purposes and the subject innovation is not so limited.

As discussed above, the system 800 can invoke tests on the machines 806. The substantially similar tests can be launched in parallel on multiple machines and new dynamic test machines can be added through data files (e.g. XML files, etc.). Test on different machines 806 can be launched by a utility referenced as “Test Launcher.exe” which takes a data file (e.g., XML file) as input containing details of the test machines 808. For instance, a sample file is illustrated below:

```
  <?xml version=‘1.0’?>
<root>
      <Configuration>
      <inTestConfigXml>E:\ScheduleJob\TestMatrixConfig.xml
</inTestConfigXml>
        <outTestConfigXml>\\rfid-
build\public\testdlls\Tools\TestConfig.xml</outTestConfigXml>
      <CopyTestConfigBatFile>E:\ScheduleJob\
ToolsCopyTestConfig.bat</CopyTestConfigBatFile>
      <BlackBoxBatFile>E:\ScheduleJob\ToolsDevBlackBoxJob.cmd
</BlackBoxBatFile>
      </Configuration>
      <TestOnDays>
        <Monday>1,2</Monday>
        <Tuesday>1,2</Tuesday>
        <Wednesday>1,2</Wednesday>
        <Thursday>1,2</Thursday>
        <Friday>1,2</Friday>
        <Saturday>1,2</Saturday>
        <Sunday>1,2</Sunday>
      </TestOnDays>
      <Test>
        <TestID>1</TestID>
        <Name>rfid-1pxps-1</Name>
        <ClientType>Local</ClientType>
        <ClientLocation>rfid-1pxps-1</ClientLocation>
        <RFIDServiceLocation>rfid-1pxps-1</RFIDServiceLocation>
        <StoreType>Local</StoreType>
        <BuildMachineName>rfid-build</BuildMachineName>
        <StoreLocation>rfid-1pxps-1</StoreLocation>
        <StoreDBName>rfidstore</StoreDBName>
        <SinkType>Local</SinkType>
        <SinkLocation>rfid-1pxps-1</SinkLocation>
        <SinkDBName>rfidsink</SinkDBName>
      <ServiceInstallationPath>C:\RTT2.1\Client\sb\statements\
ToolsDevBlackBox\bin</ServiceInstallationPath>
      </Test>
</root>
```

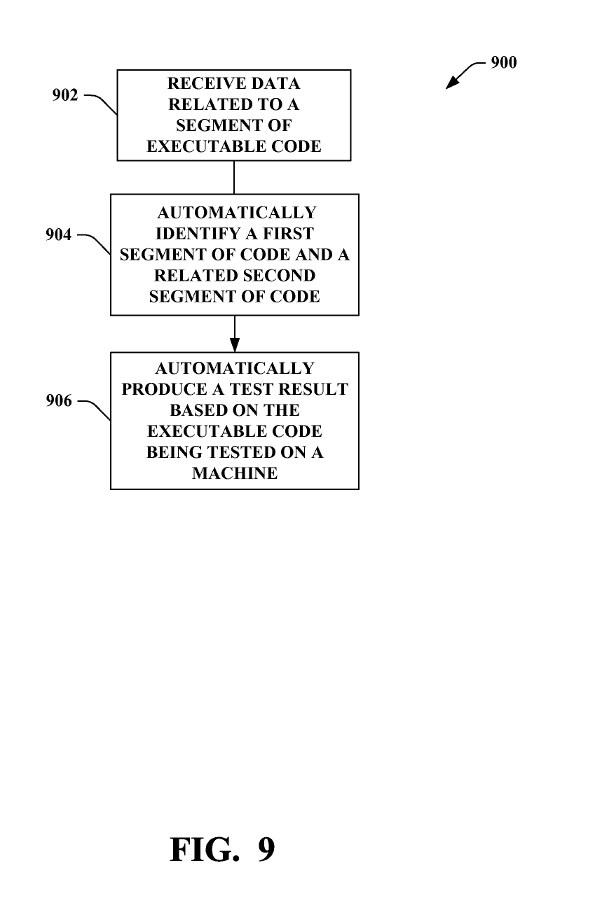

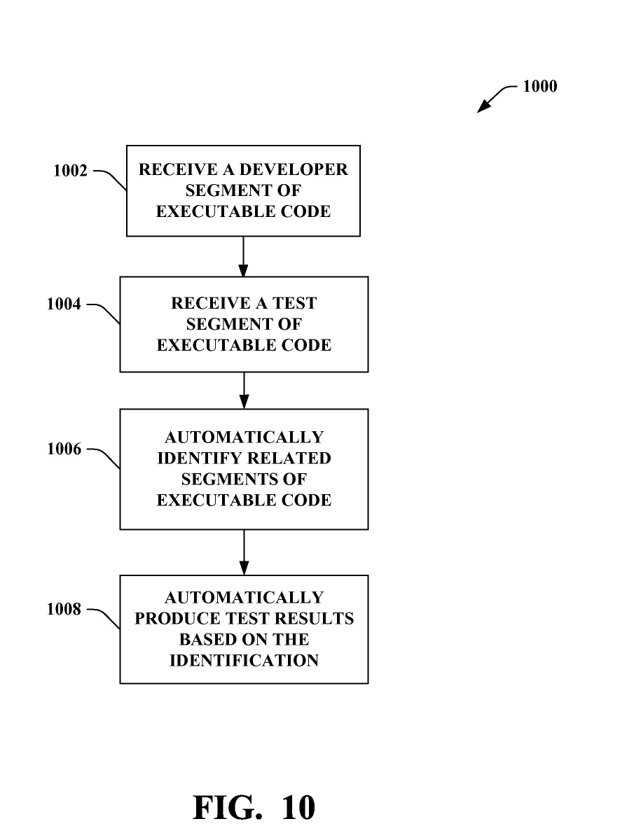

FIGS. 9-10 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 9 illustrates a methodology 900 for automatically testing software. At reference numeral 902, data related to a segment of executable code can be received. The data can be any suitable software code associated with at least one of a test kit, a segment of executable code, a software code, extensible markup language (XML), C sharp, C++, structured query language (SQL), hypertext markup language (HTML), any suitable software code, and/or any combination thereof. For instance, the data can be a developer segment of executable code and a test segment of executable code.

At reference numeral 904, related segments of executable code can be automatically identified. Thus, a first segment of code and a related second segment of code can be automatically identified, wherein such segments can be utilized in combination to provide testing. In one example, a developer segment of code and a respective test segment of code can be received, wherein such related segments can be automatically identified. At reference numeral 906, a test result can be automatically produced based at least in part upon the automatically identified code segments by testing such code on a machine, computer, system, etc. In general, the data can be received, automatically identified, compiled, and automatically tested without any manual interaction.

Moreover, the methodology 900 can be utilized in conjunction with an RFID infrastructure, wherein data related to the RFID infrastructure can be automatically identified, compiled, and tested. For instance, the RFID infrastructure can include an RFID server within a host that can communicate with an RFID network of physical devices via a provider, wherein the devices can receive wirelessly transmitted data from a tag. For example, the data received can be related to at least a portion of an RFID process related to the RFID infrastructure. Such data can be automatically identified (e.g., a developer segment of code matched with a test segment of code), compiled, tested, and reported.

FIG. 10 illustrates a methodology 1000 for automatically detecting a test kit and respective executable code and producing a test result. At reference numeral 1002, a developer segment of executable code can be received. The developer segment of executable code can be, for instance, suitable software code associated with at least one of a product and a test kit, a segment of executable code, a software code, extensible markup language (XML), C sharp, C++, structured query language (SQL), hypertext markup language (HTML), any suitable software code, and/or any combination thereof. At reference numeral 1004, a test segment of executable code can be received. It is to be appreciated that the test segment of executable code can be, but is not limited to being, suitable software code associated with at least one of a product and a test kit, a segment of executable code, a software code, extensible markup language (XML), C sharp, C++, structured query language (SQL), hypertext markup language (HTML), any suitable software code, and/or any combination thereof.

At reference numeral 1006, related segments of executable code can be automatically identified. For instance, a developer segment of executable code can be automatically identified with a test segment of executable code and/or vice versa. It is to be appreciated that the developer data need not be created and/or uploaded by a developer and the test data need not be created and/or uploaded by a tester. However, the developer data can be any suitable data and/or code that can be developed, while the test data can be any suitable data and/or code that can be utilized to test the developed data. Thus, the executable segments can be ascertained in relation to various compatibilities, versions, matches, etc. At reference numeral 1008, test results can be automatically ascertained based on the automatic identification of the developer segment of executable code and the test segment of executable code. Moreover, it is to be appreciated that a report with such test results can be created and distributed to any suitable entity, target, user, system, component, machine, data store, etc.

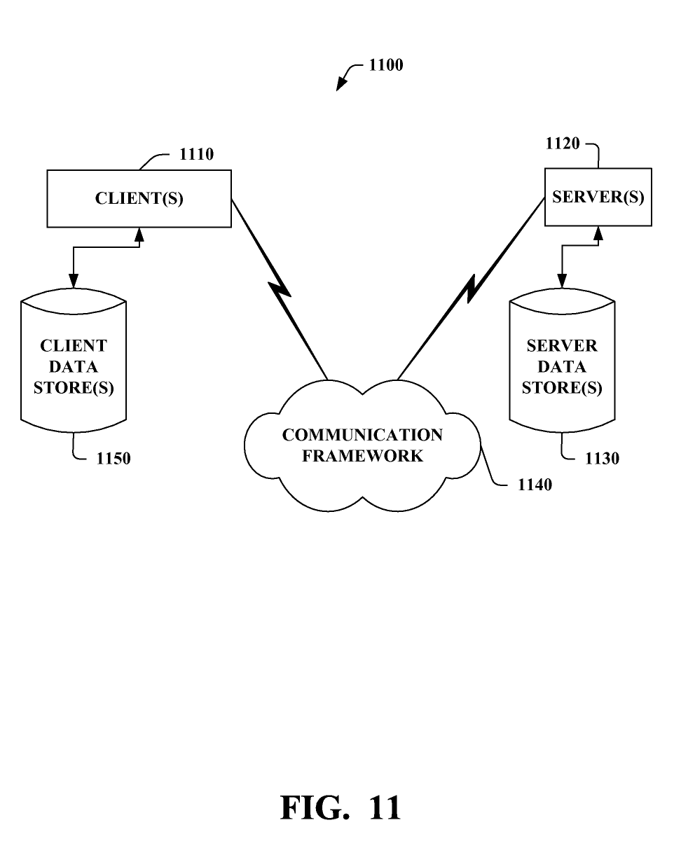

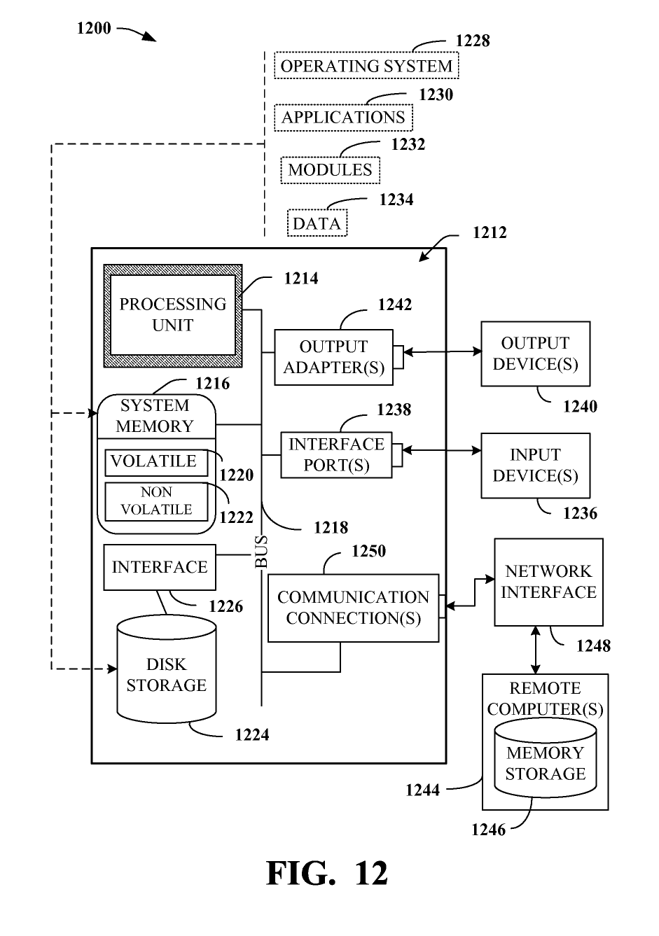

In order to provide additional context for implementing various aspects of the claimed subject matter, FIGS. 11-12 and the following discussion is intended to provide a brief, general description of a suitable computing environment in which the various aspects of the subject innovation may be implemented. For example, a test component that automatically identifies a test kit related to a segment of executable code and provides a test result, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates automatically testing software code, comprising:
an interface that facilitates receipt of a segment of executable code; and
a test component that automatically identifies a test kit related to the segment of executable code and produces a test result.

2. The system of claim 1, the test component automatically compiles the segment of executable code.

3. The system of claim 2, the compilation of the segment of executable code produces at least one of a dynamically linked library (DLL) file and an executable file.

4. The system of claim 1, the test component dynamically produces the test result in relation to receipt of the segment of executable code and the test kit.

5. The system of claim 1, further comprising a source depot in a central location that stores at least one of the segment of executable code and the test kit.

6. The system of claim 1, the software code is related to at least one of a radio frequency identification (RFID) process and an RFID network.

7. The system of claim 6, the RFID process is a high-level object that forms together at least one entity to create a meaningful unit of execution that relates to at least one of the following: an outbound process; a manufacturing process; a shipping process; a receiving process; a tracking process; a data representation process; a data manipulation process; a security process; and a process utilizing one of an RFID device service, a device collection, a tag read, an event, an event queue, a tag write, a device configuration, and a number count.

8. The system of claim 6, the RFID network comprises a collection of devices that form a sub-system which includes:
an RFID reader that receives an RFID signal; and
an RFID tag that transmits to at least one device.

9. The system of claim 1, further comprising an identify component that automatically identifies a relationship between a developer segment of executable code and a test segment of executable code.

10. The system of claim 1, further comprising a source depot that is centrally located and receives at least one of a developer segment of executable code and a test segment of executable code.

11. The system of claim 10, further comprising a build machine that builds at least one of the developer segment of executable code and the test segment of executable code.

12. The system of claim 11, further comprising a controller machine that manages and schedules at least one of the following: 1) a test job to implement for each build of a job; and 2) a test execution on at least one machine.

13. The system of claim 12, further comprising at least one test machine that performs the test.

14. The system of claim 13, further comprising a test backup machine that stores at least one test result from at least one test machine.

15. They system of claim 1, further comprising a report generator that creates at least one of a test summary, a test kit result report, a test result report, and a code coverage report.

16. The system of claim 1, the test kit result is distributed a target, the target is at least one of a portable device, a laptop, a desktop computer, a mobile device, a portable digital assistant, an email, a report, a user, a group of users, a product team, and a database.

17. A computer-implemented method that facilitates automatically testing software code, comprising:
receiving data related to a segment of executable code;
automatically identifying a first segment of code and a related second segment of code; and
automatically producing a test result based on the executable code being tested.

18. The method of claim 17, further comprising:
compiling the executable code to produce at least one of a dynamically linked library file and an executable file; and
reporting the test result to an entity.

19. The method of claim 17, producing the test result based on executable code related to an RFID infrastructure.

20. A computer-implemented system that facilitates automatically testing software code, comprising:
means for receiving a segment of executable code;
means for automatically identifying a test kit related to the segment of executable code; and
means for automatically producing a test result for the segment of executable code.
